(19) United States
(12) Patent Application Publication
(10) Pub. No.: US 2014/0146553 A1
(43) Pub. Date: May 29, 2014

(54) LIGHTING MODULE FOR A VEHICLE LIGHTING DEVICE WITH SEMICONDUCTOR LIGHT SOURCE

(71) Applicant: OSRAM GMBH, Muenchen (DE)

(72) Inventors: Oliver Hering, Niederstotzingen (DE); Juergen Hager, Herbrechtingen (DE); Stephan Schwaiger, Ulm (DE)

(73) Assignee: OSRAM GMBH, Muenchen (DE)

(21) Appl. No.: 14/074,879

(22) Filed: Nov. 8, 2013

(30) Foreign Application Priority Data
Nov. 29, 2012 (DE) 10 2012 221 908.0

(51) Int. Cl. F21K 99/00

(52) U.S. Cl. CPC F21K 9/58
USPC 362/509; 362/235

(57) ABSTRACT

In various embodiments, a lighting module for a vehicle lighting device is provided. The lighting module may include a light generating unit having at least one semiconductor light source arranged on a common substrate; wherein at least one module diaphragm introduced into a beam path of the light generating unit is arranged on the lighting module.

### CROSS-REFERENCE TO RELATED APPLICATION

This application claims priority to German Patent Application Serial No. 10 2012 221 908.0, which was filed Nov. 29, 2012, and is incorporated herein by reference in its entirety.

### TECHNICAL FIELD

Various embodiments relate generally to a lighting module for a vehicle lighting device, including a light generating unit having at least one semiconductor light source arranged on a common substrate. Various embodiments additionally relate to a vehicle lighting device, including an optical unit for generating a light emission pattern by means of light emitted by the lighting module, said optical unit being disposed downstream of the lighting module. Various embodiments are applicable to LED headlights.

### BACKGROUND

Vehicle lighting devices are known which include an light emitting diode (LED) module—also called “LED basic light source”—having a plurality of LEDs that emit white light and an optical unit disposed downstream of the LED module. The LEDs are often present as LED chips. The LED module functionally corresponds to a conventional illuminant, e.g. an incandescent lamp. The optical unit serves for generating a light emission pattern by means of light emitted by the LED module and typically includes one or a plurality of reflector shells, e.g. a half-shell reflector. In the case of vehicle lighting devices in the form of automobile headlights, in order to generate a prescribed bright-dark boundary e.g. of a light emission pattern of a low-beam light, either a diaphragm—often also called shutter—is introduced into a beam path of the light generating unit. Such an optical unit is often designated as a projector optical unit. Alternatively, a multifaceted freeform headlight uses edges of the LED basic light source and images the latter directly to the bright-dark boundary. In the case of a projector optical unit, a primary ellipsoid-like reflector collects light from the light source and concentrates said light in an intermediate plane. The abovementioned shutter is also positioned in said intermediate plane. A lens images the intermediate plane in order to realize the desired light distribution outside the headlight. Furthermore, there are also directly imaging lenses, lens systems and lens arrays, but they tend to be used less often. The directly imaging lenses, lens systems and lens arrays are more generally included among the directly imaging refractive systems.

The LED module additionally often itself has an optical edge having a high contrast ratio, e.g. the edge of an LED chip or of a group of LED chips or “chip arrays”. However, the high contrast ratio of the optical edge is particularly pronounced only on one side of the LED chips or of the chip array. On the other side, electrical contacts for the LED chips, potting compounds, etc. are typically found on the module, and lead to an impairment of the contrast ratio. The location or position of the LED chips is correspondingly adapted to the optical system such that a “good” side or edge of the LED chips or of a corresponding chip array can be used by the optical system. This concerns, in various embodiments, the abovementioned multifaceted freeform reflectors and directly imaging refractive systems. However, this purportedly simple solution gives rise to diverse logistical problems. In this regard, depending on the construction of the LED module in the headlight according to installation position and optics, possibly different versions of a product then have to be kept available. Furthermore, technical problems regarding structural space, e.g. with regard to plugs, cables, electronic constructions, etc., and problems with thermal linking can arise since all the components of the LED module likewise have to be adapted owing to the asymmetry of the contrast ratio.

### SUMMARY

In various embodiments, a lighting module for a vehicle lighting device is provided. The lighting module may include a light generating unit having at least one semiconductor light source arranged on a common substrate; wherein at least one module diaphragm introduced into a beam path of the light generating unit is arranged on the lighting module.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows one possible light generating unit in a view obliquely from above;

FIG. 2 shows in a view obliquely from above one possible lighting module with light generating unit inserted therein;

FIG. 3 shows in plan view from above a lighting module with a mount and a light generating unit inserted therein at the top side;

FIG. 4 shows the lighting module from FIG. 3 as a sectional illustration in side view;

FIG. 5 shows in plan view the lighting module from FIG. 3 with additionally a module diaphragm placed thereon;

FIG. 6 shows the lighting module from FIG. 5 as a sectional illustration in side view;

FIG. 7 shows in plan view from above another lighting module with a mount, a light generating unit inserted therein at the top side, and another module diaphragm placed thereon;

FIG. 8 shows the lighting module from FIG. 7 as a sectional illustration in side view;

FIG. 9 shows in a view obliquely from the front a module diaphragm for a plurality of groups of light emitting diodes;

FIG. 10 shows yet another lighting module as a sectional illustration in side view; and

FIG. 11 shows a group of light emitting diodes of a light generating unit which are arranged in a matrix-type manner.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The above-described properties, features and advantages of this invention and the way in which they are achieved will become clearer and more clearly understandable in connection with the following schematic description of embodiments which are explained in greater detail in connection with the drawings. In this case, for the sake of clarity, identical or identically acting elements may be provided with identical reference signs.

Various embodiments may at least partly overcome the disadvantages of the prior art.

Various embodiments provide a lighting module for a vehicle lighting device, including a light generating unit having at least one semiconductor light source arranged on a common substrate, wherein at least one diaphragm introduced into a beam path of the light generating unit is arranged or fitted on the lighting module. Said diaphragm introduced into a beam path of the light generating unit is designated as “module diaphragm” hereinafter for differentiation from the diaphragm situated in the optical unit or disposed downstream of the optical unit, which is the “main diaphragm” or shutter.

This lighting module has the advantage that it allows the light emitting diode (LED) module to be positioned more freely without impairing the orientation to the bright-dark boundary. Technical problems regarding structural space (plugs, cables, electronic constructions, etc.) or problems with thermal linking can thus be reduced or avoided. In various embodiments, the advantages can be achieved by virtue of the fact that, by means of the module diaphragm, optical edges are produced at the light beam of the LED module with an equally sharp contrast ratio. By way of example, it is possible to rotate the LED module by 180° in the case of sharp optical edges that are opposite in a parallel fashion, without changing the orientation with respect to the main diaphragm or shutter. Moreover, cost savings and logistical advantages arise as a result of a smaller number of required product derivatives. It is also possible to achieve an improved tolerance in the positioning of the semiconductor light sources relative to the optical unit. Furthermore, a complex form of the optical edge can thus be provided using compact means.

A lighting module may be understood to mean, in various embodiments, a light-generating device whose light has to be shaped still further in order to be suitable as a vehicle lighting device, e.g. by means of an optical unit disposed downstream. The lighting module is therefore in various embodiments part of a vehicle lighting device, but more highly integrated than the semiconductor light source.

A vehicle lighting device may be understood to mean, in various embodiments, a luminaire provided for specifying light of a vehicle toward the outside. The vehicle lighting device may be, for example, a headlight, a rear light, an indicator, etc. The vehicle may be e.g. a motor vehicle (car, e.g. passenger car, motorcycle, tractor, etc.), a ship, an aircraft, etc.

The light generating unit may e.g. also be designated as a “light engine” or the like.

The substrate may be for example a solid body, e.g. composed of ceramic, or a printed circuit board. The substrate may be of plate-shaped design, in various embodiments. In various embodiments, a ceramic substrate for one or a plurality of semiconductor chips (e.g. LED chips) may also be designated as a “submount”.

The semiconductor light source may be, in various embodiments, a light emitting diode (LED) or a diode laser. The light emitting diode may be a conversion diode, in various embodiments. The semiconductor light source may be a packaged or an unpackaged semiconductor light source. An unpackaged semiconductor light source may be present in various embodiments as a chip (e.g. as a so-called “bare die”), in e.g. as an LED chip. A size of an emission surface of the chips may be e.g. between 0.5 mm×0.5 mm and 1.5 mm×1.5 mm, in e.g. 1 mm×1 mm, but may generally also encompass other sizes and form factors.

Instead of or in addition to LED chips, however, e.g. OLEDs or wavelength-converting conversion elements irradiated by at least one semiconductor light source can also be used. In various embodiments, conversion elements, for example phosphors (so-called “remote phosphor”), excited by (e.g. visible or non-visible) laser light may be used (“Laser Activated Remote Phosphor”, LARP).

In one development, the at least one semiconductor light source includes a plurality of semiconductor sources. The latter may be arranged in various embodiments in a matrix arrangement on the substrate, e.g. in a regular (rectangular) matrix form, e.g. the arrangement 5×1, 4×1, 5×2, 3×3, 2×10, ete.

In one configuration, the module diaphragm circumferentially surrounds the at least one semiconductor light source. It is thereby possible to achieve a sharp contrast at all marginal points or marginal sections of the light beam emitted by the LED module. Surrounding circumferentially may therefore be understood to mean, in various embodiments, an arrangement in which the module diaphragm surrounds the at least one semiconductor light source circumferentially with respect to a main emission direction of the at least one semiconductor light source. A main emission direction may be, in various embodiments, a direction of a highest light intensity or luminous flux. In other words, the module diaphragm in this configuration has (at least) one cutout for passage of the light generated by the at least one semiconductor light source.

The module diaphragm may therefore be configured, in various embodiments, as a perforated diaphragm. In this case, the edges of the cutout produce the optical edge of the LED module. The form of the cutout is not restricted and can be rectangular or oval, for example, or else contain a specific form (such as a 15° angle), which is necessary for a low-beam light distribution in a directly imaging refractive system.

In various embodiments, the form of the cutout may have a basic form similar to an external contour or enclosure of the at least one semiconductor light source. If, by way of example, a plurality of semiconductor light sources are arranged in a regular (rectangular) matrix pattern, the form of the cutout may also correspond to a rectangular form (common to the semiconductor light sources).

Alternatively, the module diaphragm may block the light beam emitted by the at least one semiconductor light source only partly for the purpose of increasing the contrast, e.g. at opposite, e.g. parallel, sides.

In principle, the module diaphragm may be of integral or multipartite design.

In another configuration, the module diaphragm partly covers at least one semiconductor light source, e.g. in plan view or along the main emission direction. A particularly high contrast ratio may thus be attained. Moreover, it is thus possible to eliminate irregularities in the external contour of the at least one semiconductor light source in the light beam.

In one development, the module diaphragm covers at least one semiconductor light source in the region of a contact region of at least one semiconductor light source. It is thereby possible, in various embodiments, to eliminate an irregularity in the external contour of the light beam which occurs in some LED chips which have at the top side alongside the emission surface an electrical contact region which permits no light emission locally there.

In one development, the module diaphragm does not cover or leaves free at least one semiconductor light source, e.g. in plan view or along the main emission direction.

In a further configuration, the module diaphragm consists of metal, ceramic or a similarly heat-resistant material, as a result of which it is extremely temperature-resistant. This may be advantageous on account of the comparatively small distance with respect to the at least one semiconductor light source and the high optical irradiances prevailing there.

In one development, the lighting module includes a plurality of semiconductor light sources which form a plurality (at least two) of groups spaced apart from one another. In this case, a distance between semiconductor light sources in a group, in various embodiments two adjacent semiconductor light sources in said group, is significantly smaller, in various embodiments at least five times smaller, than a distance between two groups. The different groups can be arranged on a common substrate or on different substrates. The different groups can be thermally connected to a common heat sink or to different heat sinks, e.g. via the associated substrate.

In one configuration, furthermore, the module diaphragm is a common module diaphragm for a plurality of mutually spaced-apart groups of semiconductor light sources. This facilitates mounting and enables a particularly precise orientation of the respective light beams with respect to one another, in various embodiments of their optical edges. The module diaphragm may have a plurality of cutouts for this purpose, e.g. one cutout respectively for each of the groups, e.g. in a manner similar to a stencil.

In one configuration, moreover, the module diaphragm is fixedly connected to a (“primary”) optical unit for the at least one semiconductor light source. As a result, a tolerance of the construction can be improved (reduced), and mounting is simplified. By way of example, the module diaphragm may serve as a carrier or support for the primary optical unit. The primary optical unit may be, in various embodiments, an optical unit common to a plurality of semiconductor light sources, e.g. having a lens and/or a concentrator.

The module diaphragm may be connected to the primary optical unit in any suitable manner, e.g. by a force-locking connection (e.g. pressing-on, clamping, screwing, riveting, etc.), positively locking connection (e.g. latching, etc.) and/or cohesive connection (e.g. adhesive bonding, etc.).

In one development, the module diaphragm is fixed to the (rest of the) vehicle lighting device, in various embodiments to a heat sink, by means of the primary optical unit. For this purpose, the primary optical unit may have in various embodiments at least one fixing means, e.g. at least one screw hole. In another development, in the fixed state, the primary optical unit presses the rest of the module diaphragm (including e.g. a mount as explained in greater detail below) onto the (rest of the) vehicle lighting device and thus holds it in a force-locking press fit.

In one configuration, moreover, the at least one semiconductor light source includes a plurality of semiconductor light sources arranged in a matrix pattern, wherein top-side contact regions of at least some of the semiconductor light sources face inward (do not adjoin an outer edge contour of the plurality of semiconductor light sources). This means, in various embodiments, that unlike previously, for achieving short contact-making lengths (e.g. by means of short bonding wires), the contact regions are not all arranged on an outer or outside edge of a group of semiconductor light sources. The inwardly facing contact regions likewise make it possible, to be precise even without the use of the module diaphragm, to eliminate an irregularity produced by the contact regions in the optical edge. Alternatively or additionally, it is also possible to use a module diaphragm for the inner region, that is to say the region of the contact regions (e.g. in the form of at least one web), such that at least one of the contact regions is covered by the module diaphragm.

The semiconductor light sources are preferably arranged in one or a plurality of rows of two. The top-side contact regions can be arranged in various embodiments at corners of the top side (“contact corners”).

In one configuration, moreover, the light generating unit is inserted into a mount. As a result, the lighting module to which the mount belongs can be better handled and/or mechanically and electrically contact-connected. The mount can also be designated as an adapter. The mount may have, in various embodiments, a receptacle for the light generating unit. The mount may be of plate-shaped design, for example.

The module diaphragm can be fixed in various embodiments by means of standardized mechanical processes, such as e.g. by means of a force-locking connection, positively locking connection and/or cohesive connection, e.g. by means of screwing, clamping, adhesive bonding, riveting, etc., but e.g. also by means of injection molding into a plastic housing. However, the module diaphragm need not be integrated into the mount. It is likewise possible to fix the module diaphragm as an independent component or else to concomitantly integrate it into the primary optical unit.

The mount may have, in various embodiments, one or a plurality of (internal) electrical contact elements, e.g. contact lugs, contact springs, contact pins, etc., for making electrical contact with the light generating unit, and also corresponding (external) electrical contacts (e.g. contact zones or contact pins) for electrical supply. The electrical connection between the internal electrical contact elements and the external electrical contact elements may be achieved for example by means of a leadframe.

In yet another configuration, the module diaphragm is designed as at least one electrical contact element for at least one semiconductor light source. A simpler construction can be achieved as a result. In various embodiments, the module diaphragm may have the function of the internal and/or external electrical contact elements. For this purpose, the module diaphragm may have a plurality of regions electrically insulated from one another, e.g. conductor tracks applied on a ceramic support.

The mount may be pressed onto a common support, e.g. a heat sink or some other element of the vehicle lighting device, for example by means of a primary optical unit.

In another development, the mount has at least one fixing element for fixing to the primary optical unit. The primary optical unit may also include an arrangement of optical waveguides. The fixing element may be a perforated mount, for example. This facilitates positioning and orientation of the primary optical unit and thus reduces tolerances.

In various embodiments, the mount and the primary optical unit may each have at least one, preferably three, congruent screw holes or drilled holes (perforated mounts) for inserting a respective common fixing element, e.g. a screw. The screw may be led e.g. through a perforated mount of the mount and a perforated mount of the primary optical unit and be fitted into a threaded hole in a heat sink or other element of the vehicle lighting device. This facilitates joint positioning and orientation of the primary optical unit and of the mount and reduces tolerances even further. Alternatively, the process described can also be realized by a riveting process.

In another configuration, the module diaphragm is fixed to the mount. Simpler orientation or adjustment of the module diaphragm is thereby made possible.

Alternatively or additionally, the module diaphragm may be fixed to the light generating unit.

Various embodiments provide a vehicle lighting device, including at least one lighting module as discussed above, and an optical unit, in various embodiments secondary optical unit, for generating a light emission pattern by means of light emitted by the lighting module, said optical unit being disposed downstream of the lighting module. The vehicle lighting device has the same advantages as the lighting module and may be configured analogously.

The vehicle lighting device may be a headlight, in various embodiments.

The optical unit disposed downstream may include, in various embodiments, at least one reflector, a main diaphragm or shutter and/or an imaging optical unit, e.g. at least one lens, in various embodiments disposed downstream.

Various embodiments provide a vehicle, including at least one vehicle lighting device as discussed above.

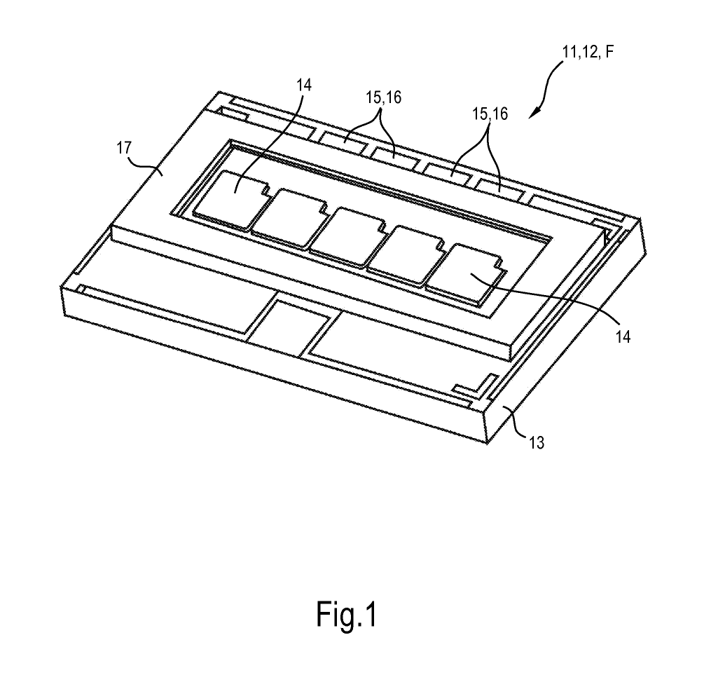

FIG. 1 shows one possible light generating unit 11 of a lighting module 12 of a vehicle headlight F in a view obliquely from above.

The light generating unit includes a plurality, here: five, of semiconductor light sources in the form of LED chips 14 that emit white light, said semiconductor light sources being applied on a front side of a common ceramic substrate 13, often also designated as a “submount”. The LED chips 14 are arranged in a matrix-type 5×1 arrangement.

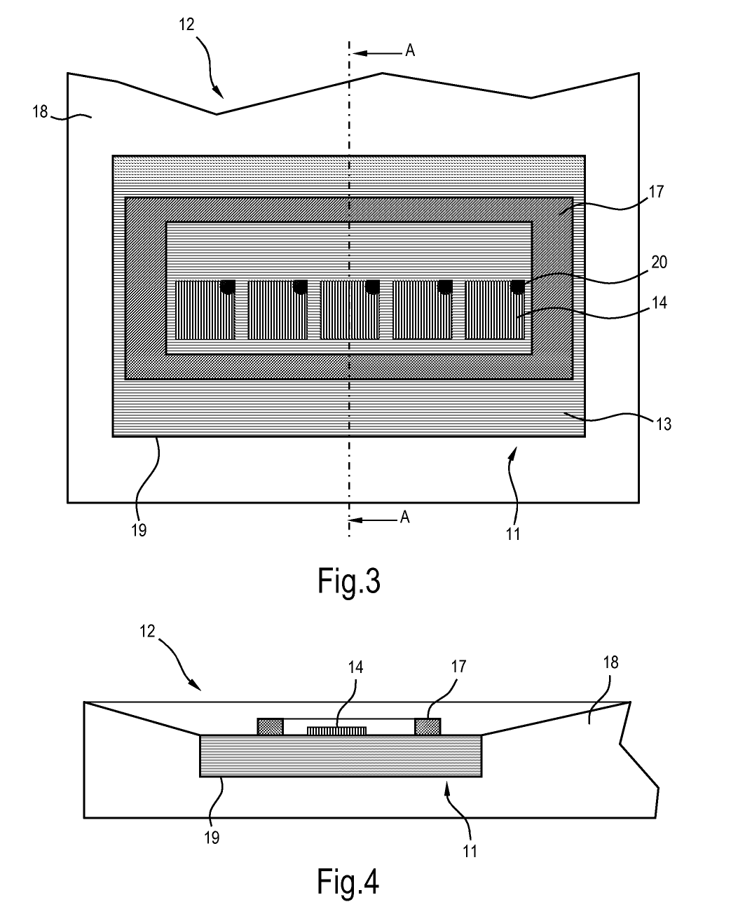

The LED chips 14 can have for example an emission surface which emits blue light and on which a blue-yellow converting phosphor is applied. The LED chips 14 have in a corner top-side contact regions, so-called “contact corners” 20, as also shown in FIG. 3, which are indicated here as a cutout.

Various conductor tracks 15 are applied on the ceramic substrate 13 in order to make electrical contact with the LED chips 14 via the contact corners thereof. The conductor tracks 15 provide contact zones 16 for this purpose. The LED chips 14 are furthermore surrounded by a frame 17 which extends circumferentially in plan view and which has a rectangular basic form, e.g. having a length ratio of approximately 5:1, that matches a common outer contour of the LED chips 14.

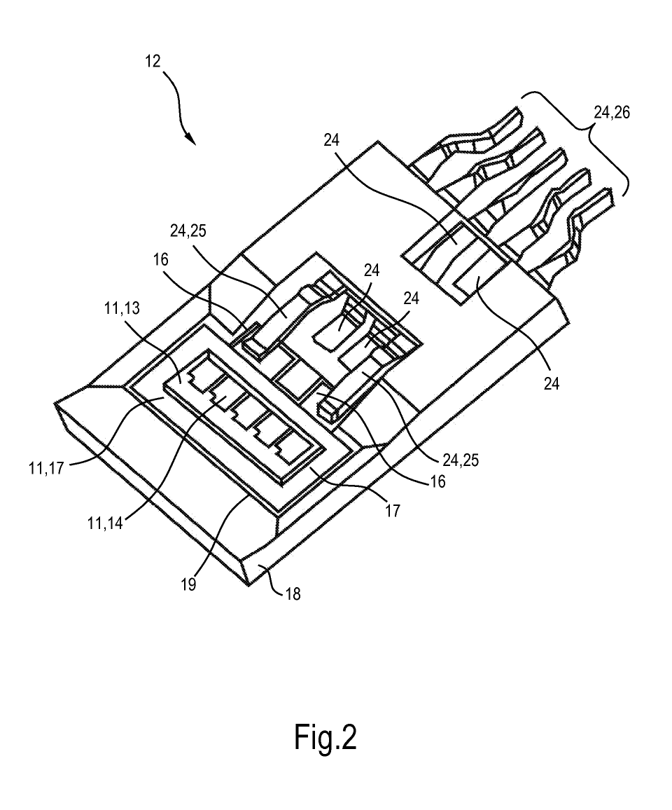

FIG. 2 shows in a view obliquely from above the lighting module 12 with a plate-like mount 18 and the light generating unit 11 inserted into a cutout 19 therein at the top side. FIG. 3 shows the lighting module 12 in plan view from above. The contact corners 20 of the LED chips 14 are depicted here. FIG. 4 shows the lighting module 12 from FIG. 2 and FIG. 3 as a sectional illustration in side view along a sectional plane A-A from FIG. 3.

The mount 18 has a leadframe 24 or line network in order to make electrical contact with the contact zones 16 of the light generating unit 11 by means of internal electrodes 25 as parts of the leadframe 24 and to electrically connect them to external electrodes likewise as parts of the leadframe 24 in the form of contact pins 26.

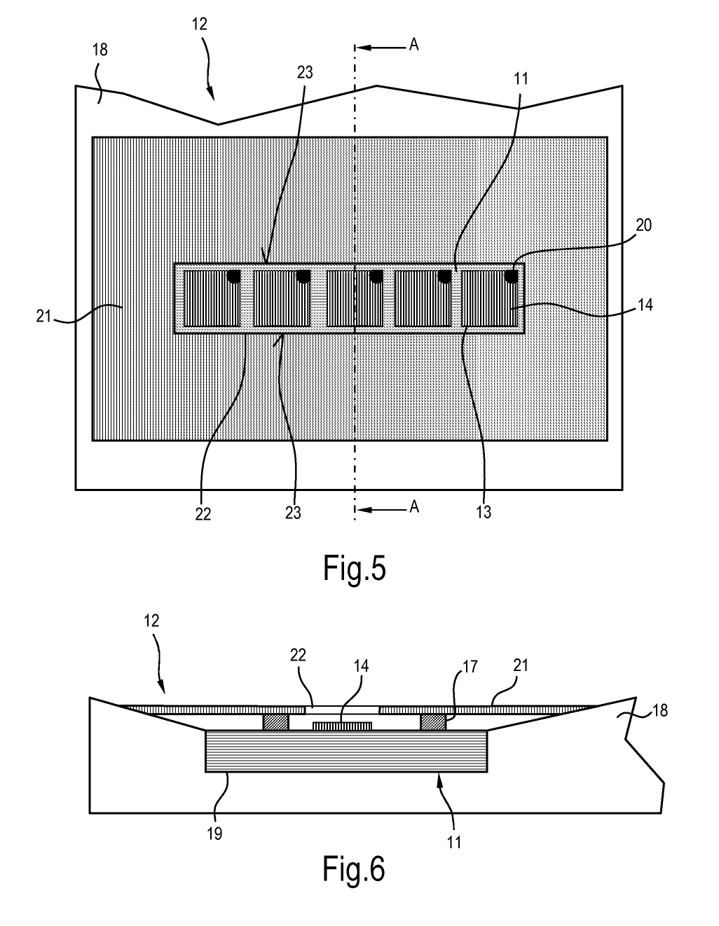

FIG. 5 shows in plan view from above the lighting module 12 with an additional module diaphragm 21. FIG. 6 shows the lighting module 12 from FIG. 5 as a sectional illustration in side view along a sectional plane A-A from FIG. 5. The module diaphragm 21 is designed as a plate-shaped perforated diaphragm composed of metal or ceramic with a rectangular cutout 22. In the plan view which is shown in FIG. 5 and which also looks along a main emission direction of the LED chips 14, the module diaphragm 21 surrounds the LED chips 14 circumferentially, to be precise in such a way that the LED chips 14 remain free and are therefore not covered by the module diaphragm 21.

The module diaphragm 21 is therefore introduced by its cutout 22 into the beam path of the light generating unit 11 and produces a sharp, high-contrast optical boundary at the edge of the cutout 22. On account of the identical and here additionally also parallel configuration of the long edges 23 of the cutout 22, the module diaphragm 21 can be rotated by 180° and nevertheless provide an identically shaped optical boundary. This considerably simplifies the positioning of the module diaphragm 21 in or on the vehicle headlight F.

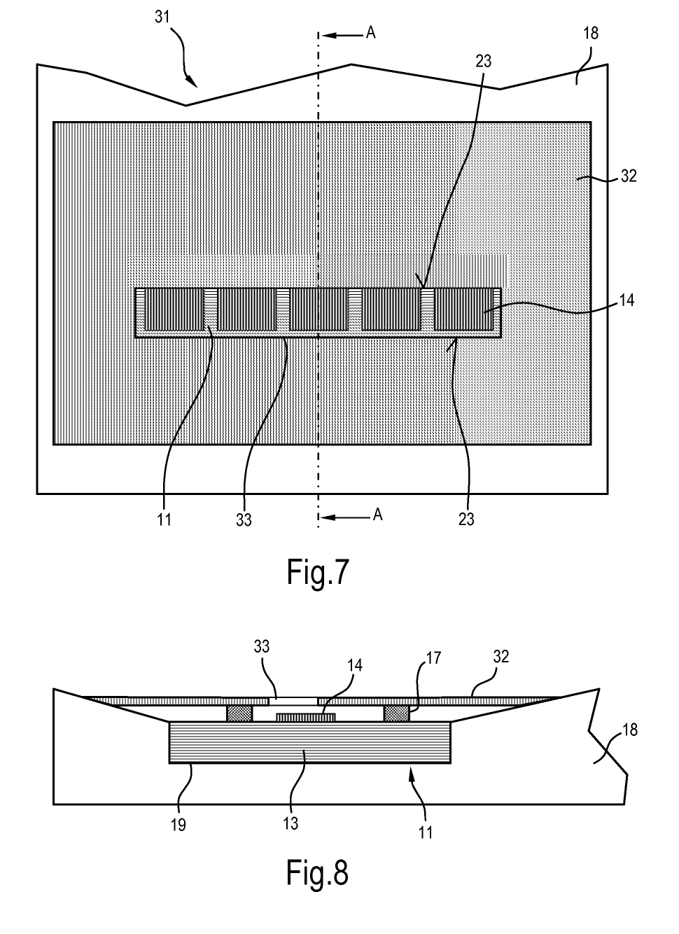

FIG. 7 shows in plan view from above a lighting module 31 with a module diaphragm 32 instead of the module diaphragm 21. FIG. 8 shows the lighting module 31 from FIG. 7 as a sectional illustration in side view along a sectional plane A-A from FIG. 7. The module diaphragm 32 differs from the module diaphragm 21 by virtue of a narrower cutout 33. As a result, the contact corners 20 and in part the emission surfaces of the LED chips 14 are also covered, which results in an even more accurate adaptation of the here at least substantially linear form of the optical boundaries in the region of the long edges 23. The brightness and thus the contrast sharpness possibly differ at the two long edges 23, but this can be compensated for e.g. by an even narrower cutout that is symmetrical with respect to the LED chips 14.

It is generally also possible also to adapt the module diaphragm, e.g. 32, on the previously unchanged side in such a way that the long sides 23 are completely symmetrical.

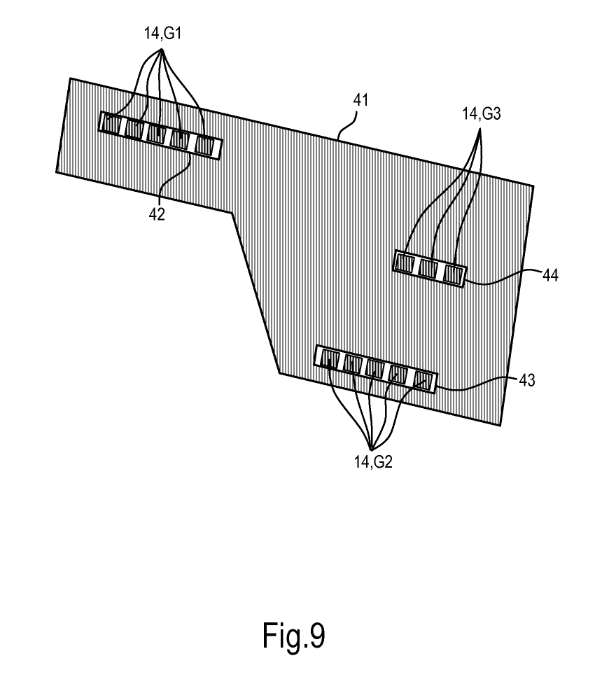

FIG. 9 shows in a view obliquely from the front a module diaphragm 41 for a plurality of mutually spaced-apart groups G1, G2, G3 of LED chips 14. The module diaphragm 41 has a respective cutout 42, 43 and 44 for each of the, here three, groups G1 to G3. The LED chips 14 here are arranged behind the module diaphragm 41 and may be arranged on a common substrate and/or a common heat sink. The cutouts 42-44 produce sharp optical boundaries for the respective groups G1 to G3 of LED chips 14.

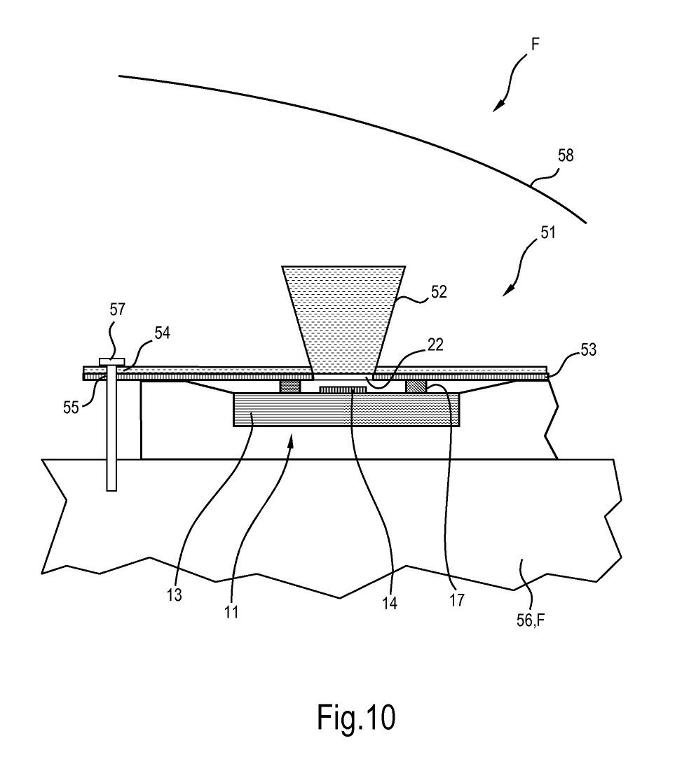

FIG. 10 shows yet another lighting module 51 as a sectional illustration in side view. The lighting module 51 is constructed similarly to the lighting module 12, but additionally has a primary optical unit 52 in the form of a concentrator, for example, which is disposed jointly downstream of the LED chips 14.

The primary optical unit 52 and the module diaphragm 53 here both have a plurality of perforated mounts with holes 54 and 55, respectively, which lie one above another and by means of which they can be screwed by means of screws 57 and/or riveted, etc. to a heat sink 56. As a result, the lighting module 51 is fixed and the primary optical unit 52 and the module diaphragm 53 are oriented precisely in relation to one another. However, by way of example, it is also possible to dispense with the perforated mounts of the module diaphragm 53.

A “main” optical unit of the vehicle headlight F, e.g. here a partially shown half-shell reflector 58, can be disposed downstream of the lighting module 51.

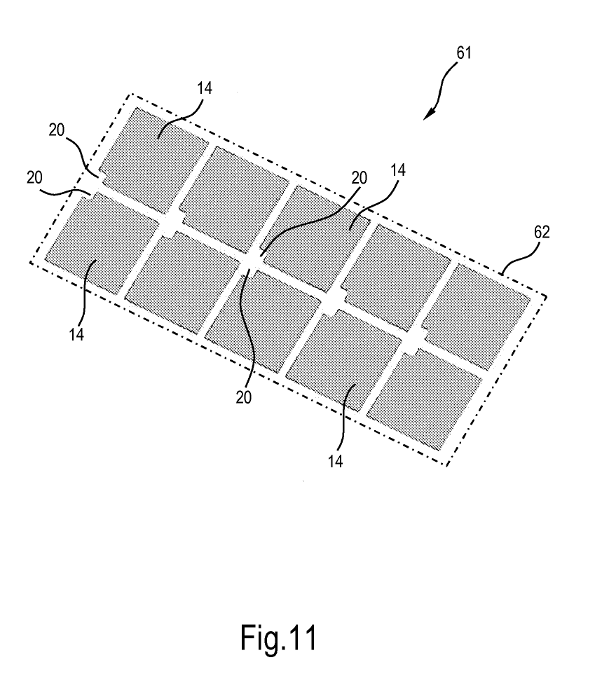

FIG. 11 shows a group of LED chips 14 of a light generating unit 61, said LED chips being arranged in a matrix-type manner in a 5×2 pattern. Contact corners 20 of adjacent LED chips 14 of the two rows face inward, that is to say are directly adjacent to one another. As a result, at least for the four pairs of LED chips 14 arranged furthest on the right, the contact corners 20 of a common rectangular external contour 62 of the LED chips 14 are moved inward, such that the outer optical edge of the LED chips 14 is more rectilinear.

Although the invention has been more specifically illustrated and described in more detail by means of the exemplary embodiments shown, the invention is nevertheless not restricted thereto and other variations can be derived therefrom by a person skilled in the art, without departing from the scope of protection of the invention.

In general, “a”, “one”, etc. can be understood to mean a singular or a plural, in various embodiments in the sense of “at least one” or “one or a plurality”, etc., as long as this is not explicitly excluded, e.g. by the expression “exactly one”, etc.

Moreover, a numerical indication can encompass exactly the indicated number and also a customary tolerance range, as long as this is not explicitly excluded.

What is claimed is:

1. A lighting module for a vehicle lighting device, the lighting module comprising:
a light generating unit having at least one semiconductor light source arranged on a common substrate;
wherein at least one module diaphragm introduced into a beam path of the light generating unit is arranged on the lighting module.

2. The lighting module of claim 1,
wherein the module diaphragm circumferentially surrounds the at least one semiconductor light source.

3. The lighting module of claim 1,
wherein the module diaphragm partly covers at least one semiconductor light source.

4. The lighting module of claim 3,
wherein the module diaphragm partly covers at least one semiconductor light source in the region of a contact region of at least one semiconductor light source.

5. The lighting module of claim 1,
wherein the module diaphragm comprises or consists of metal or ceramic.

6. The lighting module of claim 1,
wherein the module diaphragm is designed as at least one electrical contact element for at least one semiconductor light source.

7. The lighting module of claim 1,
wherein the module diaphragm is a common module diaphragm for a plurality of mutually spaced-apart groups of semiconductor light sources.

8. The lighting module of claim 1,
wherein the module diaphragm is connected to an optical unit for the at least one semiconductor light source.

9. The lighting module of claim 1,
wherein the at least one semiconductor light source comprises a plurality of semiconductor light sources arranged in a matrix pattern;
wherein top-side contact regions of at least some of the semiconductor light sources face inward.

10. The lighting module of claim 1,
wherein the light generating unit is inserted into a mount; and
wherein the module diaphragm is fixed to the mount.

11. A vehicle lighting device, comprising:
at least one lighting module, comprising:
a light generating unit having at least one semiconductor light source arranged on a common substrate;
wherein at least one module diaphragm introduced into a beam path of the light generating unit is arranged on the lighting module;
an optical unit for generating a light emission pattern by means of light emitted by the lighting module, said optical unit being disposed downstream of the lighting module.

12. A lighting module, comprising:
a light generator comprising at least one semiconductor light source arranged on a common carrier; and
at least one module diaphragm introduced into a beam path of the light generator and arranged on the lighting module.
